(19) United States
(12) Patent Application Publication
(10) Pub. No.: US 2026/0155349 A1
(43) Pub. Date: Jun. 4, 2026

(54) ELECTRODE FILM ROLL, ELECTRODE, ELECTRODE LAMINATE, ELECTROCHEMICAL DEVICE, AND APPARATUS

(71) Applicant: Fujimori Kogyo Co., Ltd., Tokyo (JP)

(72) Inventors: Takuo YONEDA, Tokyo (JP); Yasuki HIRATA, Tokyo (JP); Mitsuru TOUKURA, Tokyo (JP); Ayumi ANDOU, Tokyo (JP); Yasuhiro KANEDA, Tokyo (JP); Takuma SUZUKI, Tokyo (JP); Tetsuya SATOU, Tokyo (JP); Ryuichi SATOU, Tokyo (JP); Tsutomu HAYASHI, Tokyo (JP); Hisashi NAKAZAWA, Tokyo (JP)

(21) Appl. No.: 18/724,791

(22) PCT Filed: Dec. 28, 2022
(86) PCT No.: PCT/JP2022/048573

§ 371 Date: Jun. 27, 2024

(30) Foreign Application Priority Data
Dec. 28, 2021 (JP) 2021-214185

(51) Int. Cl. H01M 4/133; H01M 4/02; H01M 4/131; H01M 4/62; H01M 10/0525; H01M 10/0585

(52) U.S. Cl. CPC H01M 4/133; H01M 4/131; H01M 4/622; H01M 10/0525; H01M 10/0585; H01M 2004/021; H01M 2004/027; H01M 2004/028

(57) ABSTRACT

An electrode film roll made of a mixture containing an active material and a binder, said electrode film roll satisfying (1) to (3) below. (1) The rupture strength found by the following measurement method is 0.2 MPa or more. Measurement method: Rupture strength is defined as the strength at 75% of maximum stress when a test piece obtained by cutting the electrode film roll to a size of 15 mm by width and 50 mm by length is measured under the conditions of an inter-chuck distance of 30 mm and a tensile speed of 100 mm/min. (2) The electrode resistance in the IR region of a GITT waveform is 120Ω or less. (3) The electrode resistance in the ΔEτ region of the GITT waveform is 80Ω or less.

### FIELD OF THE INVENTION

The present invention relates to an electrode film roll, an electrode, an electrode laminate, an electrochemical device, and an apparatus.

Priority is claimed to Japanese Patent Application No. 2021-214185, filed Dec. 28, 2021, the content of which is incorporated herein by reference.

### BACKGROUND OF THE INVENTION

In recent years, the importance of secondary batteries used as power sources has been increasing. Secondary batteries have been actively researched and developed from small ones such as power sources for portable electronic apparatuses to medium and large ones such as those for electric vehicles and home storage batteries.

A secondary battery has a pair of electrodes containing active materials and an electrolyte disposed between the electrodes. The pair of electrodes include a positive electrode containing a positive electrode active material and a negative electrode containing a negative electrode active material. As these electrodes, a configuration in which an active material layer containing a positive electrode active material or a negative electrode active material and a current collector with excellent conductivity are laminated is known.

The active material layer is formed by dispersing a powdered active material and a binder in a solvent to produce a slurry-like mixture, applying the obtained mixture to the current collector, and pressing it. The laminate of the active material layer and the current collector is cut into a desired battery shape and used as an electrode (see, for example, Japanese Unexamined Patent Application, First Publication No. 2019-169444).

### SUMMARY OF THE INVENTION

### Technical Problem

As described above, in order to produce an electrode, multiple steps of processing such as adjustment of a mixture, application of the mixture, drying, and pressing are required. When the above technology is considered from the viewpoint of simplifying a manufacturing process for secondary batteries and reducing manufacturing costs, there is room for improvement in terms of materials.

Similar problems can occur not only in secondary batteries but also in other electrochemical elements such as capacitors.

The present invention has been made in consideration of these circumstances, and an object thereof is to provide a novel electrode film roll used for a material of an electrode. In addition, another object thereof is to provide an electrode, an electrode laminate, an electrochemical device, and an apparatus that use such an electrode film roll as a material.

### Solution to Problem

The inventors thought that, if a material having properties that allow the material to be used as an electrode without using a current collector could be realized, the above-described processing of adjustment of the mixture, application of the mixture to the current collector, and the like could be omitted. In addition, the inventors thought that, by forming the material into a film shape, cutting the film (electrode film roll), and bonding it to a battery element, an electrochemical device could be easily manufactured.

The inventors conducted extensive research from the above perspective and completed the invention. In order to solve the above problems, one aspect of the present invention includes the following aspects.

[1] An electrode film roll made of a mixture containing an active material and a binder, which satisfies the following (1) to (3).

(1) A rupture strength determined by the following measurement method is 0.2 MPa or more.

(Measurement method) When a test piece obtained by cutting the electrode film roll to a size of 15 mm wide and 50 mm long is measured under conditions of an inter-chuck distance of 30 mm and a tensile speed of 100 mm/min, a strength at 75% of the maximum stress is defined as the rupture strength.

(2) A resistance value of an electrode in an IR region of a GITT waveform determined by the following measurement method is 120Ω or less.

(Measurement method) A constant current intermittent titration method is performed by applying a constant current pulse of 0.1 C for 30 minutes to the electrode cut from the electrode film roll and set to a state of charge (SOC) of 50%.

(3) A resistance value of the electrode in a ΔEτ region of the GITT waveform determined by the above measurement method is 80Ω or less.

[2] An electrode film roll that includes an active material layer made of a material of a mixture containing an active material and a binder, and incudes no current collector, which satisfies the following (1) to (3).

(1) A rupture strength determined by the following measurement method is 0.2 MPa or more.

(Measurement method) When a test piece obtained by cutting the electrode film roll to a size of 15 mm wide and 50 mm long is measured under conditions of an inter-chuck distance of 30 mm and a tensile speed of 100 mm/min, a strength at 75% of the maximum stress is defined as the rupture strength.

(2) A resistance value of an electrode in an IR region of a GITT waveform determined by the following measurement method is 120Ω or less.

(Measurement method) A constant current intermittent titration method is performed by applying a constant current pulse of 0.1 C for 30 minutes to the electrode cut from the electrode film roll and set to a state of charge (SOC) of 50%.

(3) A resistance value of the electrode in a ΔEτ region of the GITT waveform determined by the above measurement method is 80Ω or less.

[3] The electrode film roll according to [1] or [2], further satisfying the following (4).

(4) An adhesive strength in a 90° peel test is 0.02 N/cm or more.

[4] The electrode film roll according to any one of [1] to [3], in which a release film is laminated.

[5] An electrode made of a material of the electrode film roll according to any one of [1] to [4].

[6] An electrode laminate, in which the electrode according to [5] and a separator or a solid electrolyte membrane are laminated.

[7] An electrochemical device including the electrode laminate according to [6].

[8] An apparatus including the electrochemical device according to [7].

### Advantageous Effects of Invention

According to the present invention, it is possible to provide a novel electrode film roll used for a material of an electrode. In addition, it is possible to provide an electrode, an electrode laminate, an electrochemical device and an apparatus that use such an electrode film roll as a material.

### BRIEF DESCRIPTION OF THE DRAWINGS

FIG. 1 is a schematic diagram showing an electrode film roll 1 of the present embodiment.

FIG. 2 is a graph showing an example of measurement results by GITT.

FIG. 3 is a schematic diagram showing an electrode film roll 2 of the present embodiment.

FIG. 4 is a schematic diagram of an electrochemical device 100 showing 100 including an electrode laminate 50.

### DESCRIPTION OF THE INVENTION

### [Electrode Film Roll and Electrode]

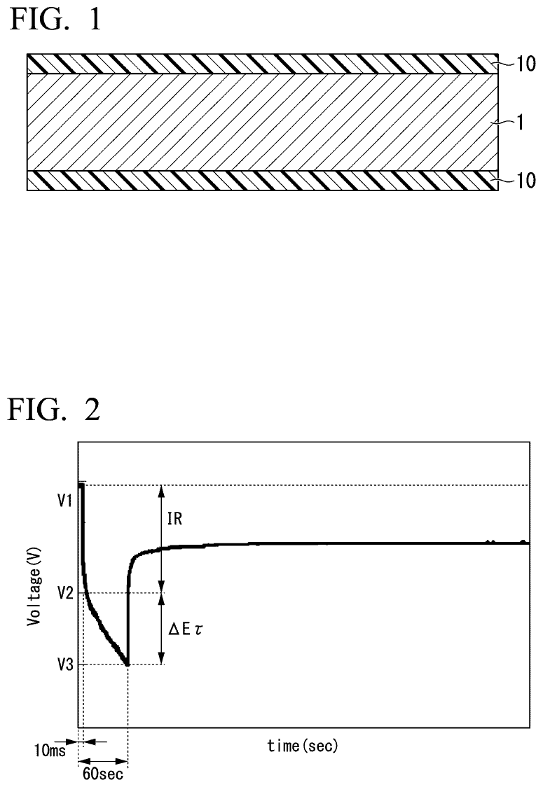

FIG. 1 is a schematic diagram showing an electrode film roll 1 of the present embodiment.

The term “electrode film roll” indicates a film-like molded body before it is processed into an electrode. Typically, the electrode film roll is an elongated molded body formed into a strip-like shape, or a sheet-like molded body obtained by processing such a strip-like molded body into sheets, but is not limited thereto.

In addition, in the following description, when a numerical range is described as “A to B,” it means “A or more and B or less.”

The electrode film roll 1 shown in FIG. 1 is interposed between release films 10 on both sides. As the release film 10, a known material such as a PET film whose surface facing the electrode film roll 1 is subjected to a release treatment can be adopted.

The electrode film roll 1 is made of a mixture containing an active material and a binder. The electrode film roll 1 does not include a current collector.

The electrode film roll 1 has the featured functions of (a) being self-supporting and (b) being usable as an electrode. In addition, the electrode film roll 1 may have the function of (c) having adhesiveness.

### (a) Self-Supporting

The electrode film roll 1 can be processed into an electrode by cutting it into a desired shape. The electrode film roll 1 may be used as an electrode as it is. The electrode obtained by cutting the electrode film roll 1 can maintain the cut shape without requiring support from accessories such as a base material. In the present specification, having such properties may be referred to as “self-supporting” or “self-supporting type.” In other words, the electrode film roll 1 has the rigidity to exist without support.

### (b) Usable as an Electrode

The electrode film roll 1 can be used as an electrode for an electrochemical device such as a secondary battery or a capacitor by cutting it into a desired shape. In other words, the electrode film roll 1 becomes an electrode for an electrochemical device simply by cutting it into a desired shape. In order to enable such a usage method, the electrode film roll 1 has low electronic resistance and high ionic conductivity to the extent that it can be used as an electrode.

### (c) Has Adhesiveness

The term “adhesiveness” means a property that allows a material to be bonded to another member due to a property of its own surface without using a separate glue or adhesive. The electrode film roll 1 functions as an electrode for a solid-state battery when it is cut into a desired shape and processed into an electrode and then bonded to a plate material formed using a solid electrolyte, for example.

The electrode obtained by cutting the electrode film roll 1 having the functions (a) and (b) is self-supporting (a self-supporting electrode) and can be used as an electrode for an electrochemical device such as a secondary battery or a capacitor simply by bonding it to a member of the electrochemical device. Further, by having the function (c), the work of bonding it to the member of the electrochemical device can be simplified.

Each configuration of the electrode film roll 1 will be described in order below.

### (Active Material)

For the active material, a powdered material known as a positive or negative electrode active material for a secondary battery, or a positive or negative electrode active material for a capacitor can be used.

When a lithium ion secondary battery is used as the secondary battery, at least one selected from a composite oxide of lithium and a transition metal such as cobalt, manganese, or nickel, and a polymer having Li storage capacity can be used as the positive electrode active material of the lithium ion secondary battery. These compounds are compounds in which lithium ions can be reversibly doped and dedoped. Aside from these, any compound that is known as a positive electrode active material and in which lithium ions can be reversibly doped and dedoped may be used as the positive electrode active material of the lithium ion secondary battery.

For example, examples of the positive electrode active material include lithium cobalt oxide (LiCoO₂), lithium manganate (LiMnO₄), lithium iron phosphate (LiFePO₄), a Ni—Mn—Co ternary (NMC-based) active material (LiNiₓMn_{y}Co_{z}O₂), and a Ni—Co—Al ternary (NCA-based) active material (LiNiₓCo_{y}Al_{z}O₂).

Examples of the negative electrode active material for the lithium ion secondary battery include at least one selected from carbon-based materials such as graphite, lithium metal, lithium compounds such as lithium titanate, metals such as aluminum, tin, and silicon that can form alloys with lithium, alloys of lithium with other metals, and metal oxides such as silicon oxide. These compounds are compounds in which lithium ions can be reversibly doped and dedoped. Aside from these, any compound that is known as a negative electrode active material and in which lithium ions can be reversibly doped and dedoped may be used as the negative electrode active material for the lithium ion secondary battery.

An active material with a volume average particle size of 0.1 to 100 μm is used as the active material for the lithium ion secondary battery. That is, when the active material is a “powdered material,” it means that the active material is a collection of a plurality of particles with a volume average particle size of 0.1 to 100 μm.

When a lithium ion capacitor is used as the capacitor, examples of the positive electrode active material of the lithium ion capacitor include carbon-based materials such as activated carbon and polymers with Li storage capacity. Any material in which lithium ions can be reversibly doped and dedoped may be used as the positive electrode active material for the lithium ion capacitor.

Examples of the negative electrode active material of the lithium ion capacitor include carbon-based materials such as graphite and the above-described negative electrode active material for the lithium ion secondary battery.

The active material of the lithium ion capacitor has a volume average particle size of 0.1 to 100 km.

### (Binder)

The binder is a material used to bind particles of the active material or the like, and a resin is used therefor, for example. For the binder, a known thermoplastic resin used for the above purpose as an electrode material can be used.

Examples of the functions of the binder include, in addition to the above-described “binding of the particles of the active material or the like,” (i) imparting a high strength to the electrode film roll, (ii) making the electrode made from the electrode film roll easier to adhere to other members, and (iii) adjusting other physical properties. The function (ii) is not essential for the above-described functions (a) and (b) required for a “self-supporting electrode,” but is important for realizing the above-described function (c). The binder having the function (i) particularly strongly will be described as a “high-strength binder,” the binder having the function (ii) particularly strongly will be described as an “adhesive binder,” and (iii) will be described as “other binders.”

### ((i) High-Strength Binder)

An elastomer can be used for the high-strength binder. A binder having properties of an elastomer can impart flexibility and strength to the electrode and can inhibit damages caused by volumetric changes in the active material when the electrode is used.

The high-strength binder desirably has a tensile strength of 5 MPa or more. It can be said that a higher tensile strength of the high-strength binder is desirable because a higher strength can be imparted to the electrode., and may be 50 MPa or less, or may be 25 MPa or less.

The tensile strength of the high-strength binder adopts a value measured using a measurement method of a rupture strength, which will be described below.

In addition, the high-strength binder is required to be stable against an electrolyte inside an electrochemical element (a battery or a capacitor) and is required to be electrochemically stable. For example, when a lithium-ion battery is used as the electrochemical element and an electrode obtained by cutting the electrode film roll 1 is used, the high-strength binder is required not to dissolve from the electrode into the electrolyte filled in the battery. Also, when the electrode is used as a positive electrode, the high-strength binder is required not to undergo oxidative decomposition at 3 to 5 V (vs. Li/Li+). Further, when the above electrode is used as a negative electrode, the high-strength binder is required not to undergo reductive decomposition at 0 to 3 V (vs. Li/Li+).

The facts that “there is no oxidative decomposition at 3 to 5 V (vs. Li/Li+)” and “there is no reductive decomposition at 0 to 3 V (vs. Li/Li+)” can be confirmed by the well-known linear sweep voltammetry (LSV) measurement.

### (Production of Coin Cell for Measurement)

As a test electrode, a coating film made of a binder is formed to a thickness of 5 to 20 μm on Al foil for oxidative decomposition measurement and on Cu foil for reductive decomposition measurement.

The test electrode produced was disposed on a bottom cover of a coin type battery R2032. A separator (Celgard 2300, manufactured by Celgard) is disposed on the test electrode, and then an electrolyte (1 mol/L solution of LiPF₆) is poured in. A mixed solvent of ethylene carbonate, diethyl carbonate, and ethyl methyl carbonate in a 1:1:1 (volume ratio) was used as a solvent of the electrolyte.

A counter electrode (metallic lithium) is disposed on the separator to cover it, which is then left to stand for 12 hours to completely soak in the electrolyte, thereby producing a lithium secondary battery (a coin cell for measurement).

For the coin cell for measurement, 100 cycles are repeated under a scanning condition of 10 mV/sec. The coin cell for measurement using a test electrode with no binder applied is used as a blank, and if a decomposition current due to the binder is equal to or less than a decomposition current of the electrolyte, it is determined that the binder does not decompose under the measurement conditions.

For the binder, a copolymer containing styrene and a conjugated diene can be used. Examples of such a copolymer include the following.
Styrene-butadiene copolymer (SBR)
Styrene-isoprene copolymer
Styrene-butadiene-methyl methacrylate copolymer (MBS)
Acrylonitrile-styrene-butadiene copolymer (ABS)
Acrylonitrile-styrene-butadiene-methyl methacrylate copolymer (MABS)
Carboxy modified styrene butadiene rubber
Styrene-butadiene-styrene block copolymer (SBS)
Styrene-isoprene-styrene block copolymer (SIS)
Styrene-isoprene-butadiene-styrene block copolymer (SIBS)

The above copolymers may be copolymerized with other copolymerizable vinyl monomers.

Examples of vinyl monomers include the following.
Acrylate-based monomers such as alkyl acrylate
Methacrylate-based monomers such as alkyl methacrylate
Acrylamide-based monomers such as alkoxyacrylamides
Methacrylamide-based monomers such as alkoxymethacrylamides
Carboxylic acid-based monomers such as acrylic acid
Nitrile-based monomers such as acrylonitrile
Vinyl ester-based monomers such as vinyl acetate
Vinyl halide-based monomers such as vinyl chloride
Multifunctional monomers such as allyl acrylate

One of these vinyl-based monomers may be copolymerized in the copolymer, or two or more vinyl monomers may be copolymerized.

((ii) Adhesive Binder)

For the adhesive binder, a resin material having a reactive functional group or an anchor effect can be used. Examples of the reactive functional group include a hydroxyl group (—OH) and a carboxyl group (—COOH). In a case in which the electrode film roll contains such a binder, when the electrode obtained from the electrode film roll is bonded to another member, the reactive functional group is expected to react at a bonding surface, thereby increasing the adhesive strength.

In addition, since the electrode film roll includes the adhesive binder, the self-supporting electrode manufactured from the electrode film roll is more likely to exhibit the function (ii) above.

The adhesive binder is electrochemically stable and desirably has adhesiveness even when exposed to other members, especially the electrolyte.

For example, when a lithium ion battery is adopted as the electrochemical element and an electrode obtained by cutting the electrode film roll 1 is used, it is required that the adhesive binder does not dissolve from the electrode into the electrolyte filled in the battery, and that the reactive functional group is not easily deactivated even when exposed to the electrolyte. It can be said that the adhesive binder having these properties has adhesiveness even when exposed to the electrolyte.

In addition, when the electrode is used as a positive electrode, the adhesive binder is required not to undergo oxidative decomposition at 3 to 5 V (vs. Li/Li+). Further, when the electrode is used as a negative electrode, the adhesive binder is required not to undergo reductive decomposition at 0 to 3 V (vs. Li/Li+). The adhesive binder having these properties can be said to be electrochemically stable.

As such a binder, at least one selected from a carboxymethyl cellulose (CMC)-based binder, a polyacrylic acid (PAA)-based binder, a vinyl alcohol-based binder, and an epoxy-based binder can be exemplified.

Further, as the adhesive binder, polyisobutylene (PIB) can also be used.

((iii) Other Binders)

Further examples of binders that can be used in combination include acrylate-based binders, polyvinylidene fluoride (PVdF)-based binders, and polyimide-based binders. These binders can make up for the lack of functionality of the electrode. For example, (i) high-strength binders are considered to be electrochemically inactive (insulating). For that reason, if the active material is completely covered with the (i) high-strength binder, it is considered that the electrochemical reaction of the active material will not occur and the resistance of the electrode will increase. In contrast, by using (iii) other binders as described above in combination, it is considered that the increase in resistance caused by covering the active material with an inactive binder can be inhibited.

Blending of the above (i) to (iii) binders is adjusted on the basis of the following guidelines in accordance with desired physical properties.

The (i) high-strength binder mainly plays the role of binding the active material in the electrode (electrode film roll). For that reason, an amount of the (i) high-strength binder is adjusted in a positive correlation with an amount of the active material used.

Also, when the amount of the (i) high-strength binder used is increased relative to the active material, it can impart flexibility and strength to the electrode. Further, some (i) high-strength binders exhibit adhesiveness.

On the other hand, the (i) high-strength binder is insulating, and thus, when the amount used is increased, a resistance in an IR region increases.

The (ii) adhesive binder imparts adhesiveness to the electrode film roll. The adhesiveness of the electrode is determined by an amount of the adhesive binder present per unit area (unit volume), and thus, when the amount of the (ii) adhesive binder used is increased, the adhesiveness of the electrode improves.

On the other hand, when mixed with the active material, the (ii) adhesive binder tends to cover a surface of the active material and inhibit transport of ions, and thus increasing the amount used increases a resistance in a ΔEτ region.

(iii) Other binders are added as necessary to compensate for insufficient functions as the electrode.

Blending of the binders (i) to (iii) is set to satisfy requirements (1) to (3) described below, in consideration of properties of each binder described above, according to the purpose. Further, a total amount of the binder relative to the active material is set to satisfy the requirements (1) to (3) described below in consideration of the properties of each binder.

Other examples of preferred binders include a mixture of (i) styrene-butadiene copolymer and (ii) polyacrylic acid with a mass ratio of (i):(ii)=1:4 to 3:2.

Further, if the requirements (1) to (3) described below are satisfied, a mixture of a plurality of (ii) adhesive binders (for example, polyisobutylene) of different types can also be used.

The mixture that forms the electrode film roll may contain, in addition to the above-described active material and binder, additives such as a conductive material as necessary to adjust the physical properties. Examples of the conductive material include at least one selected from carbon black such as acetylene black, carbon fiber, activated carbon, metal powder, conductive polymers, and the like. The conductive material does not need to have activity like the active material, and may be a material that improves conductivity inside the electrode.

Also, the mixture that forms the electrode film roll may contain carbon nanotubes (CNTs). The electrode film roll to which CNTs have been added can be expected to improve in rupture strength and conductivity.

A thickness of the electrode film roll is preferably 1 μm to 1000 μm

The electrode film roll made of the mixture of the above materials (a molded body obtained by forming the mixture of the above materials into a film shape) satisfies the following requirements (1) to (3) in order to achieve the above functions (a) and (b). Further, the electrode film roll may satisfy the following requirement (4) in order to achieve the above function (c).

### (Requirement (1))

As described above, the electrode film roll 1 has the feature of being “(a) self-supporting.” The electrode film roll 1 having such rigidity has the rupture strength of 0.2 MPa or more as measured by the following measurement method.

(Method for measuring rupture strength) When a test piece obtained by cutting the electrode film roll to a size of 15 mm wide and 50 mm long is measured under conditions of an inter-chuck distance of 30 mm and a tensile speed of 100 mm/min, a strength at 75% of the maximum stress is defined as the rupture strength.

A magnitude of a tensile force (N) when the test piece breaks is defined as the maximum stress, and a stress at 75% of the maximum stress is determined. The rupture strength is determined by dividing the stress (N) at 75% by a cross-sectional area (mm²) of the test piece in an imaginary plane perpendicular to a tensile direction (N/mm²=MPa).

The measurement is carried out five times, and an arithmetic average of the five measurements is used as the rupture strength.

Since the electrode film roll has such rupture strength, the electrode cut from the electrode film roll can be made to be self-supporting. By making the electrode self-supporting, handling of the electrode is facilitated in the subsequent assembly process.

The rupture strength is preferably 0.1 MPa or more, and more preferably 0.2 MPa or more. Also, a higher rupture strength is preferable because it is less likely to break, and it may be 10 MPa or less, or may be 5 MPa or less.

### (Requirements (2) and (3))

As described above, the electrode film roll 1 has the feature of being “(b) usable as an electrode.” The electrode film roll 1 having such properties satisfies the following requirements (2) and (3).

Requirement (2): A resistance value of the electrode in the IR region is 120Ω or less.

Requirement (3): A resistance value of the electrode in the ΔEτ region is 80Ω or less.

### (Production of Coin Cell for Measurement)

The produced test electrode is disposed on the bottom cover of the coin cell R2032. The separator (Celgard 2300, manufactured by Celgard) is disposed on the test electrode, and then the electrolyte (1 mol/L solution of LiPF₆) is poured in. A mixed solvent obtained by mixing ethylene carbonate, diethyl carbonate, and ethyl methyl carbonate in a 1:1:1 (volume ratio) is used for the solvent of the electrolyte.

The counter electrode (metallic lithium) is disposed on the separator to cover it, which is then left to stand for 12 hours to completely soak in the electrolyte, thereby producing the lithium secondary battery (coin cell for measurement).

(Method for measuring resistance value) The resistance value for the requirements (2) and (3) is measured using the galvanostatic intermittent titration technique (GITT). FIG. 2 is a graph showing an example of measurement results using GITT. The horizontal axis is a measurement time (unit: seconds), and the vertical axis is a measured potential (unit: V).

For more details on GITT, first, the electrode is cut out from the electrode film roll and the state of charge (SOC) is set to 50%. In that case, a large-capacity charging and discharging system (Series 4000, manufactured by Maccor) can be used for a measuring device. In order to obtain the electrode with the SOC of 50%, first, charging to the SOC of 100% is performed at a constant current of 0.1 C, and when a specified voltage is reached, it is switched to constant voltage charging, and the termination condition is when a current value reaches 0.05 C (constant current and constant voltage charging). After that, discharging to the SOC of 50% is performed at a constant current of 0.1 C, and then rested for 5 minutes. After that, a constant current pulse of 0.1 C is applied to the electrode with the SOC of 50% for 30 minutes, and the voltages before and after are measured to obtain data.

(Calculation method) As shown in FIG. 2, an initial potential of the electrode is defined as V1 (unit: V), a potential immediately after current application (10 ms) is defined as V2 (unit: V), a potential 60 seconds after the current application is defined as V3 (unit: V), a potential difference from the potential V1 to the potential V2 is defined as the “IR region,” and a potential difference from the potential V2 to the potential V3 is defined as the “ΔEτ region.” Since the potential is set so that, 60 seconds after the start of measurement, it becomes minimum during discharging and maximum during charging, and thus the potential 60 seconds after the current application becomes always V3. In addition, calculation is performed with an applied current defined as I (unit: C), a resistance of the IR region defined as R1 (unit: Q)=(V1−V2)/I, and a resistance of the ΔEτ region defined as R2 (unit: Q)=(V2−V3)/I.

As described above, in order for the electrode film roll 1 to be usable as the (b) electrode, it is required for the electrode film roll to have low electrical resistance and high ionic conductivity to be usable as the electrode. Since the electrode film roll 1 is made of the mixture containing the active material and the binder, the electrode film roll 1 usable as the electrode is required to have physical properties that do not hinder the behavior of electrons and ions in the binder and at an interface between the binder and the active material.

The requirement (2) (the resistance value of the electrode in the IR region) specifies that the behavior of electrons and ions should be less likely to be hindered in the binder. In the electrode film roll 1 having the resistance value of 120Ω or less in the IR region and the electrode manufactured from the electrode film roll 1, electrons and ions supplied to the electrode from an external circuit can reach the active material well. Here, “ions” indicates lithium ions when the electrode is used in a lithium ion secondary battery, and sodium ions when the electrode is used in a sodium secondary battery. The resistance value of the electrode in the IR region may be 0.1Ω or more.

The requirement (3) (the resistance value of the electrode in the ΔEτ region) specifies that electrons and ions should be likely to undergo interfacial reactions on the surface of the active material. In the electrode film roll 1 having the resistance value of 80Ω or less in the ΔEτ region and the electrode manufactured from the electrode film roll 1, electrons and ions supplied to the electrode from an external circuit are likely to react on the surface of the active material, and ions are likely to be inserted into and removed from the active material. In other words, the electrode film roll 1 satisfying the requirement (3) can be judged that it is likely to cause electrochemical reactions of the active material. The resistance value of the electrode in the ΔEτ region may be 0.1Ω or more.

For example, in the electrode film roll 1 and the electrode manufactured from the electrode film roll 1, the behavior of electrons and ions moving within the binder is faster than that of electrons and ions moving between the binder and the active material (causing interfacial reactions). For that reason, for the measured values using GITT, the requirements (2) and (3) are specified with the resistance value in the IR region corresponding to the behavior of electrons and ions in the binder, and with the resistance value in the ΔEτ region corresponding to the interface reaction between the binder and the active material.

The electrode film roll satisfying the requirement (2) can transfer charges suitably. In addition, the electrode film satisfying the requirement (3) undergoes charging and discharging reactions suitably. That is, the electrode film roll satisfying the requirements (2) and (3) simultaneously allows the active material contained in the electrode film roll to suitably transfer electrons and lithium ions from and to an external device or the electrolyte, and can function as an electrode for an electrochemical device.

### (Requirement (4))

The electrode film roll 1 has an adhesive strength of 0.02 N/cm or more in a 900 peel test. The electrode film roll 1 satisfying the requirement (4) has the above-described feature of “(c) having adhesiveness.”

(Method for measuring adhesive strength) The test piece for the peel test is a laminate made by bonding the electrode film roll to a metal foil. The laminate is cut to a width of 15 mm and a length of 50 mm or more to obtain a rectangular test piece. A length of the test piece may be such that a region of 30 mm or more is secured for stable measured values of the adhesive strength. When an electrode film made from the electrode film roll is used for a positive electrode, Al foil is used as the metal foil to be bonded at the time of measuring the peel test. When an electrode film made from the electrode film roll is used for a negative electrode, Cu foil is used as the metal foil to be bonded at the time of measuring the peel test.

The obtained test piece (laminate) is bonded to a side surface of a ring core with a diameter of 11 cm. In detail, a longitudinal direction of the test piece is aligned with a circumferential direction of the ring core, and the metal foil side of the test piece is bonded to the ring core. The 90° peel test is performed by pulling a electrode film portion of the test piece bonded to the ring core at a speed of 20 mm/min. The adhesive strength can be calculated as a value (N/cm) obtained by dividing a magnitude of a peel force (N) when peeling the electrode from the metal foil by a width (cm) of the electrode.

The peel test is performed three times, and an arithmetic average of the three tests is used as the adhesive strength.

Since the electrode film roll has such adhesive strength, the electrode obtained from the electrode film roll can be easily bonded to other components, facilitating the subsequent assembly process. In addition, the bonded electrode is less likely to peel off, improving reliability of the obtained electrochemical device.

Further, in the case of the electrode film roll 1 that does not satisfy the requirement (4), the electrode made from the electrode film roll 1 can be used as an electrode by bonding it to a battery component via an adhesive layer having electrical conductivity and ion conductivity.

### [Method for Manufacturing Electrode Film Roll]

The electrode film roll can be manufactured by applying a slurry (coating material) in which the above-described mixture is dissolved or dispersed in a solvent onto a support and then removing the solvent.

The solvent used is one that dissolves at least the binder. Examples of the solvent include hydrocarbon solvents, alcohol solvents, ether solvents, ketone solvents, ester solvents, amide solvents, halogen solvents, sulfur solvents, inorganic solvents, and the like.

Examples of the hydrocarbon solvents include heptane, cyclohexane, toluene, xylene, and the like.

Examples of the alcohol solvents include methanol, ethanol, and the like.

Examples of the ether solvents include tetrahydrofuran, dioxane, and the like.

Examples of the ketone solvents include acetone, methyl ethyl ketone, and the like.

Examples of the ester solvents include ethyl acetate, ethyl lactate, and the like.

Examples of amide solvents include dimethylformamide and N-methyl-2-pyrrolidone.

Examples of halogen-based solvents include chloroform and dichloromethane.

Examples of sulfur-based solvents include dimethyl sulfoxide and sulfolane.

Examples of inorganic solvents include water.

The above solvents may be used alone or in combination with a mixed solvent of two or more.

Although there are no particular limitations on a method for producing a coating material, the active material, the binder, the optionally added additives, and the like may be mixed with the solvent one by one or two or more at the same time, and dissolved or dispersed in the solvent.

There are no limitations on the order in which the solids (the active material, the binder, and the optionally added additives) are added to the solvent. Insoluble components may be added to a solution in which soluble components are dissolved in a solvent, and the insoluble components may be dispersed in the solution. Also, soluble components may be added to a dispersion liquid in which insoluble components are dispersed in a solvent, and the soluble components may be dissolved in the dispersion liquid.

After producing the slurry or solution, a solvent may be further added to adjust a viscosity of the coating material.

A state of the coating material may be adjusted by defoaming, filtration, or other processes. Additives such as a defoamer, a viscosity adjuster, a thickener, a diluent, a surfactant, and a stabilizer may be added to the coating material.

A method for applying the coating material is not particularly limited, and examples thereof include blade coating, dip coating, spray coating, bar coating, and die coating.

A coating target (support) to which the coating material is applied is preferably a resin film subjected to a release treatment. The support may be an elongated strip-like object, or a small sheet obtained by processing an elongated support into a sheet.

An electrode sheet roll can be formed by removing the solvent from a coating film formed by applying the coating material. The solvent can be removed by heating, reducing pressure, blowing air, or a combination of these.

The dried coating film may be pressed. For example, by compressing the dried coating film with a press or the like, a contact state of particles of the active material, the conductive material, or the like contained in the electrode can be improved.

When an elongated strip-like support is used, the electrode film roll may be wound into a roll shape, stored, and transported, or may be further processed into sheets to form a plurality of sheet-like electrode film roll.

In this way, the electrode film roll is obtained.

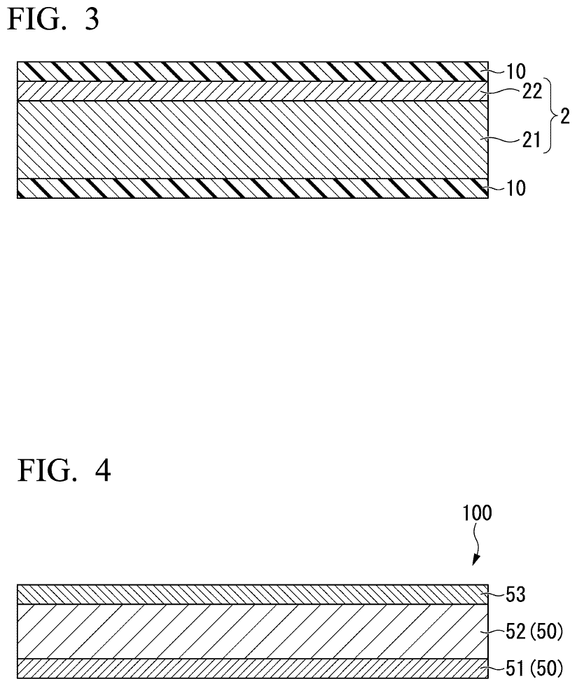

FIG. 3 is a schematic diagram showing an electrode film roll 2 of the present embodiment. The electrode film roll 2 shown in FIG. 3 includes an active material layer 21 and a functional layer 22. The electrode film roll 2 is also interposed between release films 10 on both sides. The active material layer 21 is made of a material of a mixture containing an active material and a binder.

The electrode film roll 2 does not have a current collector. In the electrode film roll 2, the active material layer 21 supports the functional layer 22.

The mixture forming the active material layer 21 can be adopt the same mixture forming the above-described electrode film roll 1.

The functional layer 22 is not particularly limited as long as it is a layer attached for the purpose of improving the functions of the electrode. The functional layer 22 can be, for example, a heat dissipation layer, a flattening layer, a stress relaxation layer, an adhesion layer, or the like.

The electrode film roll 2 also satisfies the above requirements (1) to (3). The electrode film roll 2 may also satisfy the above requirement (4).

The electrode film roll 2 can be manufactured by producing the active material layer 21 corresponding to the electrode film roll 1 in the same manner as the above-described electrode film roll 1, and then producing the functional layer 22 on a surface of the active material layer 21. The functional layer 22 can be appropriately manufactured by a known method using a known material.

The electrode film roll having the above configuration can provide a novel electrode film roll used for a material of an electrode.

In addition, the electrode having the above configuration is self-supporting and easy to handle.

### [Electrode Laminate]

FIG. 4 is a schematic diagram of an electrochemical device 100 showing 100 including an electrode laminate 50. The electrode laminate 50 is a laminate in which the above-described electrode (electrode obtained by cutting the electrode film roll 1) 51 and a layer 52 that is a separator or a solid electrolyte membrane are laminated. In the electrode laminate 50, the electrode 51 may be in direct contact with the layer 52 (a separator or a solid electrolyte membrane), or another member may be interposed between them.

The electrode laminate 50 in which the layer 52 is a separator (the electrode laminate 50 of the electrode 51 and the separator) is mainly used in an electrochemical device that uses an electrolytic solution. The electrode laminate 50 in which the layer 52 is a solid electrolyte membrane (the electrode laminate 50 of the electrode 51 and the solid electrolyte membrane) is used in an all-solid-state secondary battery, which is a type of electrochemical device.

The separator is a material that insulates between the positive electrode and the negative electrode and has ion permeability required for the functions of the electrode. The separator is not particularly limited, and a known resin film, porous membrane, or the like can be used.

Examples of the resin film include polypropylene, polyethylene, polyolefin, aramid, polyvinylidene fluoride, polyacrylonitrile, polyimide, polyamide, polyethersulfone, and the like. The resin film may be made porous to impart ion permeability.

Examples of the porous film include woven fabric, nonwoven fabric, cellulose, ceramic, and the like.

The solid electrolyte membrane is a member obtained by processing a commonly known solid electrolyte into a plate or film shape. For a material for the solid electrolyte membrane, any of commonly known inorganic solid electrolytes and polymer solid electrolytes can be used.

For the inorganic solid electrolyte, any of sulfide-based inorganic solid electrolytes, oxide-based inorganic solid electrolytes, and other lithium-based inorganic solid electrolytes can be used.

Examples of the sulfide-based inorganic solid electrolytes include Li₂S—P₂S₅, Li₂S—SiS₂, Li₂S—GeS₂, Li₂S—Al₂S₃, Li₂S—SiS₂—Li₃PO₄, Li₂S—P₂S₅—GeS₂, Li₂S—Li₂O—P₂S₅—SiS₂, Li₂S—GeS₂—P₂S₅—SiS₂, Li₂S—SnS₂—P₂S₅—SiS₂, and the like.

Examples of the oxide-based inorganic solid electrolytes include NASICON-type electrolytes such as LiTi₂(PO₄)₃, LiZr₂(PO₄)₃, and LiGe₂(PO₄)₃, and perovskite-type electrolytes such as (La_{0.5+x}Li_{0.5-3x})TiO₃.

Other lithium-based inorganic solid electrolyte materials include LiPON, LiNbO₃, LiTaO₃, Li₃PO₄, LiPO₄₋ₓNₓ (x is 0<x≤1), LiN, LiI, LISICON, and the like.

Examples of polymer-based solid electrolytes include polymeric materials that exhibit ionic conductivity, such as polyethylene oxide, polypropylene oxide, and copolymers of these.

Examples of another member interposed between the electrode 51 and the layer 52 include, for example, a protective film that protects a surface of the electrode. There are no particular limitations on the protective film as long as it is a material that can protect the electrode from particles of the active material or the like coming out of the surface of the electrode, excessive reactions between the electrolyte and the electrode, or the like.

### [Electrochemical Device]

The electrochemical device 100 includes the electrode laminate 50. In addition, the electrochemical device 100 includes a counter electrode 53 for the electrode 51 on a side opposite to the electrode 51 of the layer 52. Examples of the electrochemical device include secondary batteries and capacitors.

Examples of the secondary batteries include battery cells, modules produced by connecting a plurality of cells, and packs produced by connecting a plurality of modules. Electrochemical device products may include sensors and control circuits for preventing abnormalities such as overcharging and overdischarging. Leads (terminals) may be attached to the electrode to electrically connect the battery to the outside.

The electrode laminate 50 including the separator is used in the secondary battery having the electrolytic solution as the electrochemical device 100. Examples of the electrolyte for the lithium ion secondary battery include a solution in which a lithium salt is dissolved in a non-aqueous solvent. Examples of the lithium salt include LiPF₆, LiBF₄, LiAlCl₄, LiClO₄, CF₃SO₃Li, C₄F₉SO₃Li, CF₃COOLi, (CF₃CO)₂NLi, (CF₃SO₂)₂NLi, (C₂F₅SO₂)₂NLi, and the like. Examples of the non-aqueous solvent include carbonates (carbonic acid esters) such as ethylene carbonate (EC), propylene carbonate (PC), dimethyl carbonate (DMC), diethyl carbonate (DEC), and ethyl methyl carbonate (EMC).

The electrochemical device 100 can be produced by combining the electrode laminate with other necessary members, such as a separator and another electrode (counter electrode 53). The counter electrode 53 may be the electrode of the present embodiment obtained by cutting the electrode film roll, or may be different from the electrode of the present embodiment.

A container that contains the electrode laminate 50 can be made of a laminate film, a metal, or the like. The electrode laminate may be disposed flat in the container, or may be stored in a curved, bent, or wound state.

### [Apparatus]

A module can be produced by connecting a plurality of cells. A pack can be produced by connecting a plurality of modules. Although apparatuses produced using batteries such as cells, modules, and packs are not particularly limited, examples thereof include electronic devices such as smartphones, mobile phones, computers, and displays, and transportation devices such as electric vehicles and hybrid vehicles.

The preferred embodiments of the present invention have been described above with reference to the accompanied drawings, but the present invention is not limited to these examples. Shapes, combinations, or the like of each constituent members shown in the above-described examples are merely examples, and various changes can be made on the basis of design requirements, or the like without departing from the gist of the present invention.

### EXAMPLES

The present invention will be described below using examples, but the present invention is not limited to these examples.

### Examples 1-1 to 1-6 and 2-1 to 2-2, and Comparative Examples 1-1 to 1-6 and 2-1 to 2-7

Respective materials used in the examples and comparative examples are as follows.

### (Binder)

SBR: Styrene-butadiene rubber, manufactured by Sigma-Aldrich, model number 182877
PAA: Polyacrylic acid, manufactured by Fujimori Kogyo Co., Ltd., model number TR-853
N150: Polyisobutylene, manufactured by BASF, model number N150
6T: Polyisobutylene, manufactured by ENEOS, model number 6T

### (Negative Electrode Active Material)

Graphite: Manufactured by Showa Denko K.K., model number MAGE3

### (Positive Electrode Active Material)

NCM: Manufactured by Xiamen Tungsten Co., Ltd. (XTC), model number HEC400

### (Conductive Material)

AB: Acetylene black, manufactured by Alfa Aesar, model number 45527

Each binder was dissolved in a solvent to produce a solution with the following concentration, and then mixed in the ratios shown in Tables 1 and 2 to obtain a binder solution.
SBR: 24% by mass in toluene solution
PAA: 40% by mass in ethyl acetate solution
N150: 6% by mass in toluene solution
6T: 24% by mass in toluene solution

The active material and the conductive material (acetylene black) were mixed in the ratios shown in Tables 1 and 2 using a vibration mixer to obtain a mixed powder.

The mixed powder and binder solution were mixed in the ratios shown in Tables 1 and 2 to obtain a slurry. Toluene was further added to adjust the viscosity.

The slurry was degassed and passed through a sieve with 100 μm openings to obtain coating materials of the examples and comparative examples.

The obtained coating material was applied to a PET film subjected to a release treatment and set to 5 mAh/cm². Specifically, a mass of the active material per unit area (a mass of coating, unit: g/cm²) was calculated from a target electrode capacity and a specific capacity of the active material used (unit: mAh/g), and a target amount of the coating material was applied. The coating film was dried by heating at 120° C. for 12 minutes. After drying, it was compressed with a roll press to obtain electrode film rolls of the examples and comparative examples. A density of each electrode film roll was set to 3.2 g/cm³ for the positive electrode and 1.5 g/cm³ for the negative electrode.

A manufacturer's nominal value of the active material used was used for the specific capacity of the active material.

TABLE 1

| | Composition of electrode | | | | |
|---|---|---|---|---|---|
| | material (% by mass) | | | | |
| | | Conductive | | Composition of binder | |
| | | material | | (% by mass) | |
| | Graphite | (AB) | Binder | SBR | PAA |
| Comparative | 94 | 2 | 4 | 20 | 80 |
| Example 1-1 | | | | | |
| Example 1-1 | | | | 40 | 60 |
| Example 1-2 | | | | 60 | 40 |
| Comparative | 90 | 2 | 8 | 0 | 100 |
| Example 1-2 | | | | | |
| Example 1-3 | | | | 20 | 80 |
| Example 1-4 | | | | 40 | 60 |
| Example 1-5 | | | | 60 | 40 |
| Comparative | | | | 80 | 20 |
| Example 1-3 | | | | | |
| Comparative | | | | 100 | 0 |
| Example 1-4 | | | | | |
| Comparative | 86 | 2 | 12 | 20 | 80 |
| Example 1-5 | | | | | |
| Example 1-6 | | | | 30 | 70 |
| Comparative | | | | 40 | 60 |
| Example 1-6 | | | | | |

TABLE 2

| | Composition of electrode | | | | |
|---|---|---|---|---|---|
| | material (% by mass) | | | | |
| | | Conductive | | Composition of binder | |
| | | material | | (% by mass) | |
| | NCM | (AB) | Binder | N150 | ST6N |
| Comparative | 95 | 3 | 2 | 25 | 75 |
| Example 2-1 | | | | | |
| Example 2-1 | | | | 50 | 50 |
| Comparative | | | | 75 | 25 |
| Example 2-2 | | | | | |
| Comparative | 94 | 3 | 3 | 25 | 75 |
| Example 2-3 | | | | | |
| Example 2-2 | | | | 50 | 50 |
| Comparative | | | | 75 | 25 |
| Example 2-4 | | | | | |
| Comparative | 93 | 3 | 4 | 25 | 75 |
| Example 2-5 | | | | | |
| Comparative | | | | 50 | 50 |
| Example 2-6 | | | | | |
| Comparative | | | | 75 | 25 |
| Example 2-7 | | | | | |

### [Measurement of Rupture Strength]

The rupture strength of the electrode film roll was measured by the method described in the (Method for measuring rupture strength) described above.

### [Measurement of Adhesive Strength]

The adhesive strength of the electrode film roll was measured by the method described in the (Method for measuring adhesive strength) described above.

### [Measurement of Resistance Value]

The resistance value of the electrode film roll was measured by the GITT described above.

### [Production of Battery (Coin Cell for Measurement)]

Both the batteries using the electrode film rolls using the slurries in Table 1 and the batteries produced using the electrode film rolls using the slurries in Table 2 were produced by the following method.

Test electrodes for the coin cell R2032 were cut out from the electrode film rolls. After each member was dried in a vacuum at 105° C., they were assembled in a glove box with an argon atmosphere.

The prepared test electrode was disposed on the bottom cover for coin cell R2032. A separator (Celgard 2300, manufactured by Celgard) was disposed on the test electrode, and then an electrolyte (1 mol/L solution of LiPF₆) was injected. A mixed solvent obtained by mixing ethylene carbonate, diethyl carbonate, and ethyl methyl carbonate in a 1:1:1 (volume ratio) was used for the solvent of the electrolyte.

A counter electrode (metallic lithium) was disposed on the separator to cover it, which was then left to stand for 12 hours to completely soak in the electrolyte, thereby producing a lithium secondary battery (coin cell for measurement).

### [Charging and Discharging Test]

The lithium secondary battery produced was subjected to two cycles of charging and discharging at a current value of 0.1 C under the following conditions (1 C=5 mA/cm²).

### (Conditions)

Potential range (positive electrode): 2.5 to 4.25 V (vs. Li/Li⁺)

Potential range (negative electrode): 2.0 to 0.005 V (vs. Li/Li⁺)

Charging: Constant current charging at 0.1 C, followed by constant voltage charging at 0.025 C

Discharging: Constant current discharging at 0.1 C

Specifically, the test was performed in a 25° C. environment as follows. Using a large-capacity charging and discharging system (Series 4000, manufactured by Maccor), the positive electrode with the initial potential of 2.5V was charged at a constant current of 0.1 C rate until it reached 4.25 V, and then charged at a constant voltage of 4.25 V until the current reached 0.025C rate to obtain the positive electrode with the SOC of 100%.

After a 5-minute break, the positive electrode was discharged at a constant current of 0.1 C rate until it reached the SOC of 50%, obtaining the positive electrode with the SOC of 50%. After a 5-minute break, it was charged by applying a constant current pulse at 0.1 C rate for 30 minutes.

The measurement by GITT was performed during this constant current charging at 0.1 C rate.

After another 5-minute break, it was discharged at a constant current of 0.1 C to the SOC of 50%, resulting in the positive electrode with the SOC of 50%.

### [Method for Measuring SOC-OCV Value]

The amount of active material contained in the test electrode produced from the electrode film roll was calculated, and a theoretical capacity of the test electrode (mAh/g) was calculated from a theoretical capacity of the active material and the amount of active material.

Next, the produced lithium secondary battery was charged at 0.1 C for 30 minutes and then rested for 5 minutes, which was counted as one cycle, and the same operation was repeated a total of 22 cycles.

The number of cycles until the voltage reached 0.05 V was set as an SOC-OCV value.

When the SOC-OCV value measured by the above method was 16 times or more, the electrode was determined to be sufficiently usable.

Evaluation results are shown in Tables 3 and 4. In the tables, “unmeasurable” for the rupture strength means the test piece was too fragile to measure. In addition, “unmeasurable” for the adhesive strength means that the adhesive strength was weak and the electrode peeled off naturally, and “cohesive failure” means that the adhesive strength was strong and the electrode film failed during measurement of the adhesive strength.

In addition, “IR region (Q)” in Tables 3 and 4 indicates the resistance value of the electrode in the IR region of the GITT waveform, and “ΔEτ region (Q)” indicates the resistance value of the electrode in the ΔEτ region of the GITT waveform. In Tables 3 and 4, “SOC-OCV (times)” indicates the SOC-OCV value measured by the above method.

TABLE 3

| | Rupture | IR | ΔEτ | Adhesive | |
|---|---|---|---|---|---|
| | strength | region | region | strength | SOC-OCV |
| | (MPa) | (Ω) | (Ω) | (N/cm) | (times) |
| Comparative | Unmea- | 2 | 22 | Cohesive | 20 |
| Example 1-1 | surable | | | failure | |
| Example 1-1 | 0.20 | 8 | 14 | 0.02 | 20 |
| Example 1-2 | 0.31 | 19 | 10 | Unmea- | 20 |
| | | | | surable | |
| Comparative | Unmea- | 3 | 101 | Cohesive | 15 |
| Example 1-2 | surable | | | failure | |
| Example 1-3 | 0.21 | 9 | 66 | 0.20 | 19 |
| Example 1-4 | 0.34 | 28 | 42 | 0.06 | 20 |
| Example 1-5 | 0.50 | 103 | 24 | 0.02 | 16 |
| Comparative | 0.67 | 407 | 13 | Unmea- | 7 |
| Example 1-3 | | | | surable | |
| Comparative | 0.81 | >1000 | 9 | Unmea- | 2 |
| Example 1-4 | | | | surable | |
| Comparative | 0.27 | 65 | 119 | Cohesive | 11 |
| Example 1-5 | | | | failure | |
| Example 1-6 | 0.45 | 86 | 80 | 0.34 | 16 |
| Comparative | 0.62 | 124 | 56 | 0.25 | 10 |
| Example 1-6 | | | | | |

TABLE 4

| | Rupture | IR | ΔEτ | Adhesive | |
|---|---|---|---|---|---|
| | strength | region | region | strength | SOC-OCV |
| | (MPa) | (Ω) | (Ω) | (N/cm) | (times) |
| Comparative | Unmea- | 37 | 81 | Cohesive | 15 |
| Example 2-1 | surable | | | failure | |
| Example 2-1 | 0.49 | 77 | 48 | Cohesive | 20 |
| | | | | failure | |
| Comparative | 0.70 | 150 | 27 | 0.02 | 10 |
| Example 2-2 | | | | | |
| Comparative | 0.51 | 50 | 152 | Cohesive | 11 |
| Example 2-3 | | | | failure | |
| Example 2-2 | 0.83 | 92 | 63 | 0.11 | 18 |
| Comparative | 1.18 | 225 | 39 | 0.04 | 7 |
| Example 2-4 | | | | | |
| Comparative | 0.82 | 63 | 207 | Cohesive | 8 |
| Example 2-5 | | | | failure | |
| Comparative | 1.23 | 120 | 78 | 0.20 | 12 |
| Example 2-6 | | | | | |
| Comparative | 1.54 | 300 | 50 | 0.07 | 4 |
| Example 2-7 | | | | | |

Since the coin cells for measurement were chargeable and dischargeable, it has been understood that the test electrodes produced from the electrode film rolls function as electrodes for the coin cells. for measurement. In particular, it has been confirmed that the test electrodes of each example have the SOC-OCV of 16 or more and are usable as electrodes. That is, it has been confirmed that the electrode film rolls of the present embodiment can be used as electrodes simply by cutting them.

Further, it has been confirmed that the rupture strength of each electrode film roll, except for Comparative Examples 1-1, 1-2, and 2-1, satisfies the requirement (1) and was able to be self-supporting.

From the above results, it has been understood that the present invention is useful.

### REFERENCE SIGNS LIST

1, 2 Electrode film roll
10 Release film
21 Active material layer
22 Functional layer
50 Electrode laminate
51 Electrode
52 Layer (separator or solid electrolyte membrane)
100 Electrochemical device

What is claimed is:

1. An electrode film roll made of a mixture containing an active material and a binder, which satisfies the following (1) to (3).
(1) A rupture strength determined by the following measurement method is 0.2 MPa or more.
(Measurement method) When a test piece obtained by cutting the electrode film roll to a size of 15 mm wide and 50 mm long is measured under conditions of an inter-chuck distance of 30 mm and a tensile speed of 100 mm/min, a strength at 75% of the maximum stress is defined as the rupture strength.
(2) A resistance value of an electrode in an IR region of a GITT waveform determined by the following measurement method is 120Ω or less.
(Measurement method) A constant current intermittent titration method is performed by applying a constant current pulse of 0.1 C for 30 minutes to the electrode cut from the electrode film roll and set to a state of charge (SOC) of 50%.
(3) A resistance value of the electrode in a ΔEτ region of the GITT waveform determined by the above measurement method is 80Ω or less.

2. The electrode film roll comprising an active material layer made of a material of a mixture containing an active material and a binder, and incudes no current collector, which satisfies the following (1) to (3).
(1) A rupture strength determined by the following measurement method is 0.2 MPa or more.
(Measurement method) When a test piece obtained by cutting the electrode film roll to a size of 15 mm wide and 50 mm long is measured under conditions of an inter-chuck distance of 30 mm and a tensile speed of 100 mm/min, a strength at 75% of the maximum stress is defined as the rupture strength.
(2) A resistance value of an electrode in an IR region of a GITT waveform determined by the following measurement method is 120Ω or less.
(Measurement method) A constant current intermittent titration method is performed by applying a constant current pulse of 0.1 C for 30 minutes to the electrode cut from the electrode film roll and set to a state of charge (SOC) of 50%.
(3) A resistance value of the electrode in a ΔEτ region of the GITT waveform determined by the above measurement method is 80Ω or less.

3. The electrode film roll according to claim 1, further satisfying the following (4).
(4) An adhesive strength in a 90° peel test is 0.02 N/cm or more.

4. The electrode film roll according to claim 1, wherein a release film is laminated.

5. An electrode made of a material of the electrode film roll according to claim 1.

6. An electrode laminate, wherein the electrode according to claim 5 and a separator or a solid electrolyte membrane are laminated.

7. An electrochemical device comprising the electrode laminate according to claim 6.

8. An apparatus comprising the electrochemical device according to claim 7.

9. The electrode film roll according to claim 2, further satisfying the following (4).
(4) An adhesive strength in a 90° peel test is 0.02 N/cm or more.

10. The electrode film roll according to claim 2, wherein a release film is laminated.

11. An electrode made of a material of the electrode film roll according to claim 2.

12. An electrode laminate, wherein the electrode according to claim 11 and a separator or a solid electrolyte membrane are laminated.

13. An electrochemical device comprising the electrode laminate according to claim 12.

14. An apparatus comprising the electrochemical device according to claim 13.
